(19) United States
(12) Patent Application Publication
(10) Pub. No.: US 2010/0070527 A1
(43) Pub. Date: Mar. 18, 2010

(54) SYSTEM AND METHOD FOR MANAGING VIDEO, IMAGE AND ACTIVITY DATA

(76) Inventor: Tianlong Chen, Gaithersburg, MD (US)

Correspondence Address: 24IP LAW GROUP USA, PLLC, 12 E. LAKE DRIVE, ANNAPOLIS, MD, 21403, US

(21) Appl. No.: 12/562,539

(22) Filed: Sep. 18, 2009

Related U.S. Application Data
(60) Provisional application No. 61/098,212, filed on Sep. 18, 2008.

(51) Int. Cl. G06F 17/30

(52) U.S. Cl. 707/772; 707/E17.108

(57) ABSTRACT

A computer-implemented method for an object and activity query language wherein an object is a data type representing a thing or a being with a visual shape in an image or video frame and said activity is a data type representing an action or an event visually shown in an image or video or video frame, the method comprising the steps of storing a plurality of items in a raw data storage, said items comprising images and/or videos, processing said items in a processor and to generate and/or segment annotated information from said items and to extract object, activity and/or metadata information from said items in said first data storage, storing said annotated information in a secondary data storage, storing said extracted object, activity, and/or metadata information and said annotated information in a primary data storage, executing on a processor an identify function, wherein given a query item said identify function identifies said query item and/or finds a list of items similar to said first item; and a said query item comprises a video, a video frame, an image, a set of images, a template extracted from a video or image or images, an object, an activity, or annotated information, and displaying results of said identify function.

### CROSS-REFERENCE TO RELATED APPLICATIONS

The present application claims the benefit of the filing date of U.S. Provisional Patent Application Ser. No. 61/098,212 entitled “System and Method for Managing Video, Image and Activity Data” filed by the present inventor on Sep. 18, 2009.

Other patents and applications included material related to varying degrees include the following: “Invariant Memory Page Pool and Implementation Thereof,” U.S. Pat. No. 6,912,641 granted on Jun. 28, 2005; “Memory-Resident Database Management System and Implementation Thereof,” U.S. Pat. No. 7,318,076 granted on Jan. 8, 2008; “Distributed Memory Computing Environment and Implementation Thereof; U.S. Pat. No. 7,043,623, granted on May 9, 2006; “Image Indexing Search and Implementation Thereof,” U.S. Pat. No. 7,184,577 granted on Feb. 27, 2007; “Apparatus and Method for Biometric Database Management System,” U.S. Patent Application Publication No. US 2005/0223016 published on Oct. 6, 2005; and “Data-Driven Database Management System,” U.S. Patent Application Publication No. US 2005/0187984 published on Aug. 25, 2005.

The above-referenced patents, patent application publications and provisional patent applications are hereby incorporated by reference herein in their entirety.

### FIELD OF THE INVENTION

The present invention relates to a video, image and object and activity data management and query method and its implementation. The managed data may include object and activity information that is extracted (i.e. “digested”) from images or video clips by an image analysis algorithm (engine), and videos after digestion may be segmented into video clips, and digested video and images are associated with extracted information therefore are said to be annotated. The original video and images, the annotated video and images, and the extracted object and activity metadata information are the subject of an Object and Activity Database (OADB).

### BACKGROUND OF THE INVENTION

The “one-fits-all” traditional database architecture was originally designed and optimized for structured business data processing. This functionality when extended into other data processing (especially unstructured data processing) has proven to be limited and unsuccessful. As additional enhanced functionality is integrated into the database architecture it makes the database administration and maintenance even more complicated and therefore more costly.

Relational databases are good for management of structured text-based information, but they are not good for video, image and unstructured or semi-unstructured information extracted from image and video on object and activity. Objects of interest (or not of immediate interest) are things or beings that can include, but are not limited to, humans, buildings, vehicles, and so on. Activity can include many different kinds actions and events such as explosions, shootings, a person entering/exiting a building or entering/exiting from a car, a car making U-turn, a person digging or picking-up something, and so on. Many other activities will be apparent to those of skill in the art. The extracted information (sometimes called metadata or “template”) on object and activity may be binary-based or text-based feature vectors, matrices, and other possible metadata information in formats such as XML; the related data may also include segmented or annotated video clips and images in various video or image formats as their original video and images including MPEG2, MPEG4, MPEG7, AVI, JPEG and so on. Handling and manipulating the above mentioned data requires new paradigm of data management system.

### SUMMARY OF THE INVENTION

The present invention is a system and method for managing and manipulating video and images and their extracted (“digested”) metadata information, in which an object and activity “engine” (hereinafter referred to as “OA Engine”) is embedded inside the system. The OA Engine can analyze video and images to extract object and activity information represented as binary-based or text-based feature vectors, matrices and other metadata formats (hereinafter, video and image and extracted object and activity information, annotated video clips and images are collectively called “OA Data” to simplify the description of the invention). Therefore the system “understands” the object and activity information, and the OA Engine can classify and categorize the OA Data into categories for database indexation such that the OA Data is optimally stored inside the system and will be easily searched and retrieved using said indexation for fast retrieval. The main query method is through a new query language described herein; and a module of “query-by-example” will input a video-clip or one or multiple images, then the module with embedded OA Engine will “digest” (meaning analyzing the video or image and extracting object and activity information from them) the input and generate proper query statements to query into the system. This system also will be able to handle one of object types, i.e., biometric data (face, fingerprint, iris, hand geometry, and so on, and their respective extracted information in forms of feature vectors, matrices are called “templates”).

The invention also presents a dedicated query language built within a system for flexible query into the system. The query language may be built as an SQL extension such that it has similar query style as standard SQL for fast training and low ownership cost. Therefore a query language parser will be built into the system to parse the query language into token stream that will trigger the internal execution of OA Data search.

Further, the invention presents a graphic user interface to use graphic symbols to input the query language query into system.

In a preferred embodiment, the present invention is a method for implementing an object and activity query language, comprising the steps of providing at least data types of object and activity where the object is a data type representing a thing or a being with visual shape in an image or video frame and the activity is a data type representing an action or an event visually shown in an image or video or video frame such as an explosion, person movement, vehicle movement and so on, providing a function of identify( ) by given a first item to find a list of items that are similar to the first item or to identify the identity of the first item; and the item can be a video or a video frame, or an image or a set of images, or a template extracted from a video or image or images, or an object, or an activity, or an annotated data; and the annotated data is a characteristic or summary representation of its original video or images; and providing a function of compose( ) which creates a complex object from a plurality of existing objects with or without a defined manor, or creates a complex activity from a plurality of existing objects and/or activities; and the manor is an orientation or an order in which objects are located in physically or logically. The object and activity query language is used to query or search similar items in a database, find other information related to a given item in the database, or conduct other data manipulation operation in the database; and the database manages and stores a plurality of items; and a the item can be a video or video frame, or an image or a set of images, or a template extracted from a video or image, or an object, or an activity, or an annotated data; and the annotated data is a plurality of characteristic or summary video and images.

In another embodiment, the present invention is a method for implementing a graphic query interface for a database of objects and activities. The method comprises the steps of providing that graphic symbols are used to represent objects or activities where the object is a data type representing a thing or a being with visual shape in an image or video frame and the activity is a data type representing an action or an event visually shown in an image or video or video frame such as an explosion, person movement, vehicle movement, and so on, and where the graphic query interface then translates the graphic symbols into query statements according to query language of the database and send queries into the database and return query results.

In a preferred embodiment, the present invention is a computer-implemented method for an object and activity query language wherein an object is a data type representing a thing or a being with a visual shape in an image or video frame and the activity is a data type representing an action or an event visually shown in an image or video or video frame. An, activity data type may comprise, for example, one of an explosion, a movement of a person, or a movement of a vehicle.

The method comprises the steps of storing a plurality of items in a raw data storage, the items comprising images and/or videos, processing the items in a processor and to generate and/or segment annotated information from the items and to extract object, activity and/or metadata information from the items in the first data storage, storing the annotated information in a secondary data storage, storing the extracted object, activity, and/or metadata information and the annotated information in a primary data storage, executing on a processor an identify function, wherein given a query item the identify function identifies the query item and/or finds a list of items similar to the first item; and a the query item comprises a video, a video frame, an image, a set of images, a template extracted from a video or image or images, an object, an activity, or annotated information, and displaying results of the identify function.

The method may further comprise the steps of generating on the processor a complex object and/or activity from a plurality of existing objects or activities and storing the generated complex object and/or activity in the primary data storage. The generated complex object and/or activity may or may not have a defined manor. If it has a defined manor, the defined manor may comprise an orientation or an order in which objects are located in physically or logically.

The method additionally may further comprise the steps of providing a graphic user interface on a display, wherein graphic symbols are used to visually represent objects or activities. The graphic symbols additional may comprise object graphic symbols representing a thing or a being with visual shape in an image or video frame. The graphic query interface translates the graphic symbols entered by a user into query statements executed on the processor and displays a query result. The graphic query interface may combine multiple graphic symbols to form a query statement for a complex activity. The graphic user interface further may provide logic symbols, such as AND, OR, NOR or other known symbols, permitting a user to form logical relationships between sub-statements.

In other embodiments, the step of executing an identify function (or performing a search or query) may comprises combining a plurality of query score results. The plurality of query score results may come from a plurality of search engines.

Still other aspects, features, and advantages of the present invention are readily apparent from the following detailed description, simply by illustrating preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

FIG. 1 illustrates a conceptual block dataflow diagram of a database of objects and activities.

FIG. 2 illustrates a dataflow block diagram of query-by-example.

FIG. 3 illustrates another embodiment of database dataflow diagram when multiple member databases form a group of databases; which is a different view of FIG. 1.

FIG. 4 illustrates a conceptual graphic query interface.

FIG. 5 illustrates another conceptual graphic query interface.

### DESCRIPTION OF THE PREFERRED EMBODIMENT

In a preferred embodiment of the present invention, a database of objects and activities (“DBOA”) manages and manipulates new data types and associated operations. Table 1 (below) illustrates a brief comparison of traditional Relational Database (RDB) and a DBOA in accordance with the present invention.

TABLE 1
A brief comparison of traditional Relational Database (RDB) and a DBOA
in accordance with a referred embodiment of the present invention: (the
terminology will be understandable to those of skill in the art)

| | RDB | Database of Invention |
|---|---|---|
| Data types | char, int, timestamp, date, | object (target)*, activity, |
| | double, float, etc. | template, annotation, event, etc. |
| | (part of Standard SQL) | (part of new query language) |
| Query Language | Standard SQL | New Query Language |
| | | which is SQL extension |
| | | which means the query |
| | | language will follow |
| | | standard SQL principal and |
| | | extend from SQL to provide |
| | | flexible query capability. |
| | | The similarity of the new |
| | | query language and SQL |
| | | will make operation training |
| | | easy and lower the |
| | | ownership cost. |
| Query Parser | SQL parser | New Query Language parser |
| | which translates SQL to | which translates the new |
| | trigger internal execution | query language to trigger |
| | function calls | internal execution function calls |
| Internal Data Structure | B+, B*, R+, etc. | internal data structure |
| | different database engines | optimized for data retrieval |
| | from data vendors have | |
| | their own proprietary | |
| | internal data structures | |
| | optimized for data retrieval | |
| Execution Engine | Embedded text-based | Embedded OA Engine |
| | processing engine | (could be composed from |
| | which “understands” text- | multiple OA engines from |
| | based processing very well, | multiple vendors) |
| | and is capable of text | which “understands” |
| | matching and sorting, | object/activity information |
| | number matching and | very well and is capable of |
| | sorting, aggregation | OA processing of OA |
| | functions, and so on. | similarity matching and |
| | | retrieval, analyze and digest |
| | | incoming query video clip |
| | | then find similarities, |
| | | aggregation functions, and so on. |
| | | In case of biometric data, |
| | | the Embedded OA Engine |
| | | may include one or multiple |
| | | biometric engine(s). |
| Indexation | Indexation Engine | Indexation Engine |
| | (part of Execution Engine | (part of Execution Engine |
| | and Parser) | and Parser) |
| | which makes sure that data | which makes sure that data |
| | is stored in optimized | is stored in optimized |
| | (indexed) internal structures | (indexed) internal structures |
| | and data will be pre-sorted | such that (indexed) fast |
| | by primary key(s) such that | similarity search is possible. |
| | fast search is possible. | Due to its specialty, the |
| | By default, the index is not | indexation for built-in OA |
| | enabled, user has to | engine will be enabled by |
| | CREATE INDEX using a | default to take performance |
| | SQL statement. | advantage of OADB. |
| Functions | Text-based processing | OA-based functions such as |
| | functions such as | score( ), mapping( ), |
| | sum( ), min( ), max( ), | setparameters( ), fusion( ), |
| | length( ), and so on. | identify( ), |
| | | identifyByMultiModality( ) |
| | | and so on. |
| | | Support some functions in |
| | | regular SQL database such |
| | | as min( ), max( ), median( ), |
| | | length( ), and so on with |
| | | same or additional |
| | | functionality than its SQL |
| | | siblings. |
| Connectivity Methods | ODBC, JDBC, XML, .NET, | ODBC, JDBC, XML and so |
| | and so on. | on. |

*Note:
since “object” is a key word in regular SQL database, we may use “target” as data type to mean “object” in the actual implementation.

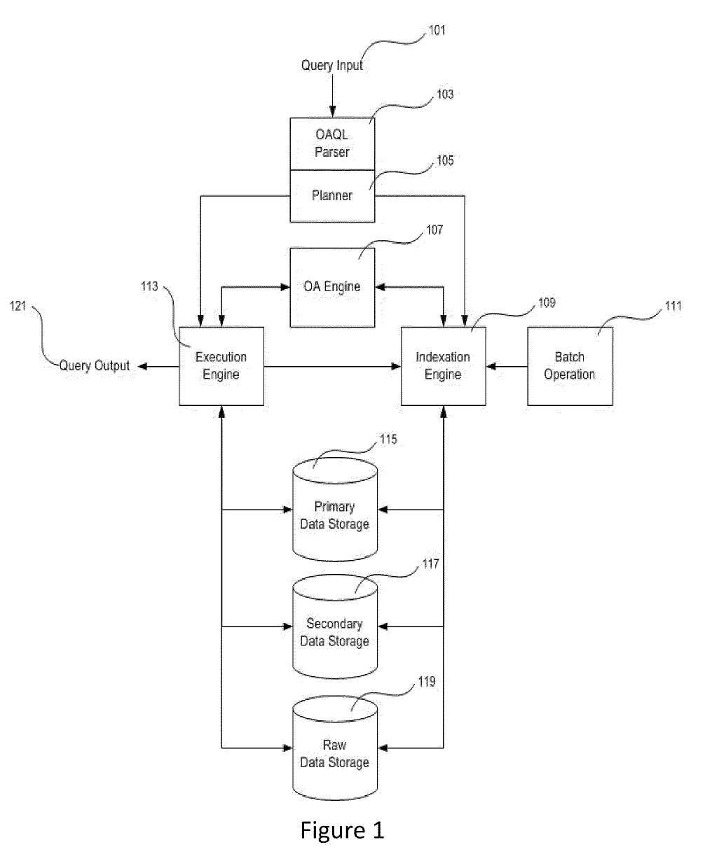

FIG. 1 illustrates the main dataflow and functional blocks inside a database of objects and activities in accordance with a preferred embodiment of the present invention.

Referring to FIG. 1, as an exemplary embodiment in accordance with the present invention, the data under the DBOA's management can include, but is not limited to the following:

(1) raw video and images (which can be generated from various sensors including but not limited to Infrared, Electronic-Optic and so on), which will be stored in a raw storage 119 (preferably disk-based file system), they will be “digested” and analyzed by OA Engine 107 on a processor, server or CPU, object and activity and other metadata information (collectively called “OA metadata”) will be extracted from these raw video and images; and

(2) characteristic or summary video-clips or images are generated or segmented (called “annotated video-clips and images” or “annotated information”) from original raw data and be stored in the secondary storage 117, the annotated video-clips and images can include visual representation of the major characteristics (or summary) of the whole video sequence or images;

The object and activity and other metadata (called “OA metadata”, in formats of binary-based or text-based feature vectors, matrices and templates) that represent the characteristics of what video and images are about and what happen are stored in the primary storage 115 which can be a memory-based database system as described, for example, in the related patents and patent application publications references herein.

The reason for such arrangement (i.e. raw data in raw data storage, annotated information in secondary data storage 117, OA metadata in primary data storage 115) is that the data in the primary storage are the “digested” information and are the most relevant information that will be queried by user. The OA metadata includes information of the related “annotated information” stored in the secondary storage 117 and its original “raw data” stored in the raw data storage 119. The data in secondary storage 117 will be the most relevant visual information representing video and images which may be output as part of query result 121. The raw data in raw data storage 119 will normally be retrieved in two situations: a) redisplay, that is, replay of the related video or images when related OA metadata is retrieved as query output, and the user wants to replay the whole or related raw data; and as option the related raw data can be chosen as output result 121 of query 101; and b) when new video and image capability are added or updated into OA Engine 107 inside the database, additional OA metadata can be extracted or more accurate OA metadata can be extracted, optionally a user can choose to operate a separate OA analysis tool equipped with an OA Engine to re-analyze the raw data to populate OA metadata in primary storage 115 and secondary storage 117.

It is preferred that raw video and images are analyzed and “digested” before they are input into the DBOA, to generate the data in the primary storage 115 and secondary storage 117;

Still referring to FIG. 1, the main operation of the Batch Operation 111 is to input large volumes of raw video and images in batch mode such that all raw data will be digested and analyzed by an OA analysis tool equipped with OA Engine (the separate OA analysis tool is not shown in FIG. 1), and be input into database. The Indexation Engine 109 will be used to index the input data and direct storage management to store data in an optimal (indexed) way. Batch Operations 111 may further include a replication operation from one database to another database in whole or in part.

Still referring to FIG. 1, a user uses new query language statements 101 to query into DATABASE OF OBJECTS AND ACTIVITIES to search similar video, images, or video or images with objects or activities of interest and/or with desired features or desired characteristics, find video or images that have similarity with input video-clip or images (as part of query input 101) when use query-by-example method.

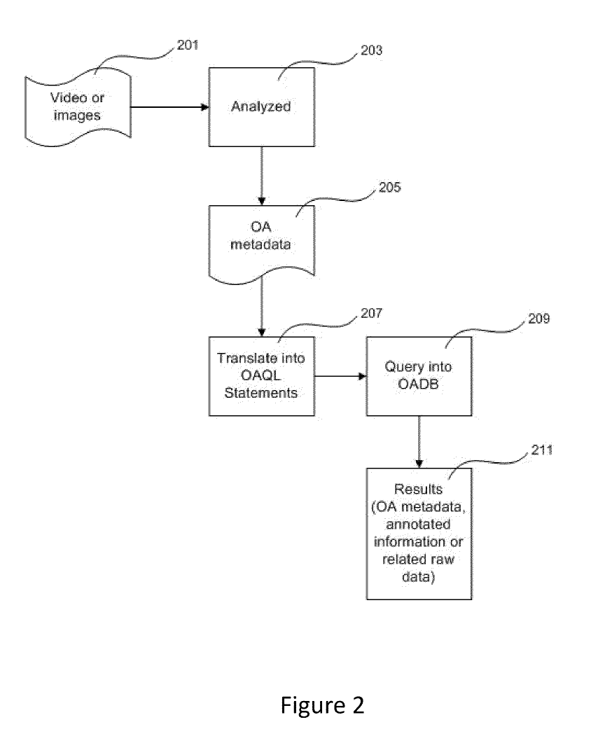

FIG. 2 illustrates a straightforward dataflow block diagram of query-by-example. Video or images 201 input as example in the query-by-example are first analyzed 203 by OA Engine to generate a set of characteristics of the input video and images 201, i.e. OA metadata 205; then OA metadata will be translated as part of an object and activity query language statement (OAQL) 207; and then the query statement will be sent 209 into OA database for searching videos or images having the similar OA metadata 205, and generate results 211 back to user, such as by displaying the results on a display or printing the results.

Referring to FIG. 1, when new query language statements get input 101 into the database of objects and activities, a new query language parser 103 will parse the statements into token streams, which are then handed over to a (optional) query Planner 105 for evaluating various possible query paths and choose an optimal one for execution, and trigger internal handling functions in Execution Engine 113 to execute the actual query, the Execution Engine 113 will search through primary storage 115 with indexation (following indexed search path set by Indexation Engine 109) or without indexation (a default maybe-brutal searching path will be followed) to fulfill the query tasks and then generate results 121 and return to user, including pulling out relevant annotated data from secondary data storage 117 and raw data from raw data storage 119 to represent to user as part of query output 121.

The new query language, as an extension of standard SQL, following the similar principal set forth in SQL standards, includes new data types and data operation functions.

In an exemplary implementation of the new query language, new data types in the new query language can include (see Table 1), but are not limited to the following:

(1) “object” (“target”) for human, building, vehicles, face, hat, box, and scene, landscape and many things with certain shape or fixed characteristics so on; in actual implementation, we choose “target” instead of object, as “object” is a key-word in regular SQL;

(2) “activity” for action and events like explosion, shooting, person entering car, person leaving from building, car U-turn, people approaching a car, person digging, person picking-up something, and so on;

(3) “template” for binary-based or text-based feature vectors, matrices of object or activity such as face template extracted from face image, fingerprint template extracted from fingerprint;

(4) “annotation” for annotated information, segmented video-clip or images; and

(5) “raw_data” for raw video and images, or the external links to the raw data. Other new data types of course are possible and will be understood by those of skill in the art.

In an exemplary embodiment of the new query language in accordance with the present invention, data operation functions in the new query language include, but are not limited to (function name can vary in different implementations, which is easily understandable for those with state of art knowledge) the following.

(1) mapping( ): since the DBOA will be able to be applied to multiple modalities of data using possibly multiple different recognition engines from different vendors to identify an object, this function is mapping the template to its proper engine, or identify the template type. An example of multiple modalities is to use face and fingerprint data to identify a person's ID or to use two different face recognition algorithm engines (i.e. multi-engine) to identify a face's ID to increase recognition rate.

(2) matching_score( ): given two same items (hereinafter, one “item” can mean one template, one set of OA metadata, one object or one activity, one video clip or one image), using proper recognition and matching algorithm in the OA Engine to return a confidence score of the two on how much they are similar to each other.

(3) identify( ): given one item (or one example video or image) with or without confidence threshold, find an identity or a list of similar candidate items with or without related OA metadata as part of query output result depending on user's input requirement; it is possible that none of similar items can be found.

(4) set_parameters( ): can be used to set (a) parameters for algorithms and engines; (b) setup similarity threshold (static or dynamic); a dynamic threshold is a variable function dependent on some parameters; (c) setting fusion function types; (d) when multiple objects in an image or video frame, whether one or multiple objects should gain focus, meaning they become the main concerns and have higher weight than non-focused objects in the similarity evaluation.

(5) fusion( ): given various scores from multiple modalities or multiple engines, a fusion function is called to generate the final result; DBOA will have a set of built-in, commonly used fusion functions for user to choose from; an example of fusion is that given a score “x1” and another “x2”, a fusion score of the two can be the simple sum “x1+x2”; interface will be provided for user to setup his/her own fusion functions.

(6) identifyByMultiModality( ): given one item using other related items to find an identity or a list of candidate items (same type of given item) with or without threshold; it is possible to find none similar ones.

(7) identifyByMultiEngine( ): given one item using multiple different recognition or analysis engines to find an identity or a list of candidate items (same type of given item) with or without threshold; it is possible to find none similar ones.

(8) compose( ): is to create a new activity from existing object types and other activity types, or create a complex “object” (possible an “object group”) from existing object types. Actually calling identifyByMultiModality( ) to identify from multiple objects is equivalent to calling identify( ) to identify a complex object made from several objects. Similarly identifyByMultiEngine( ) can be replaced by identify( ) for a complex object made from several objects created from the same original data processed by different engines. User can require DBOA to update internal data after one or multiple new objects or activities are created.

(9) the new query language supports other SQL functions such as min( ), max( ), median( ), length( ), count( ), sum( ), avg( ) and so on; the functions either have same functionality or additional functionality as their SQL siblings.

As an exemplary embodiment of the new query language, indexation on the most-used data types (such as system built-in object and activity types) will be enabled by default to take advantage of database's capability. Indexation for other data types will be enabled by using SQL statement of CREATE INDEX. Enabling indexation will trigger the database of objects and activities to manage targeted data in a storage structure that is optimally for fast searching.

As an exemplary embodiment of the new query language, structured logic statements as in SQL will be supported such as CASE . . . END for if-then logic block, START . . . END for ordered sequence of statements;

As an exemplary embodiment of the new query language, global variables of system parameters or per-database variables (when one physical database of objects and activities includes multiple logic database instances in which each instance is a logical database) can be set in a similar way as other SQL databases do.

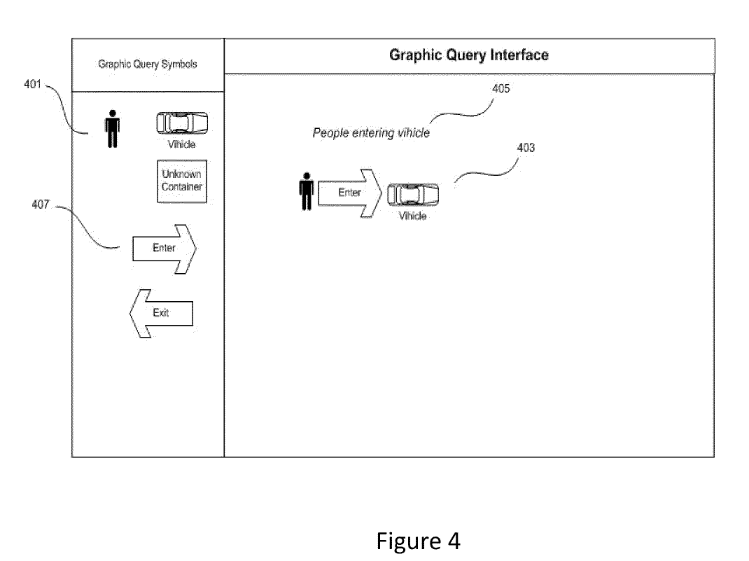

The invention discloses a graphic query interface illustrated in FIG. 4, objects and activities are represented by graphic symbols 401; action and movement are also represented by graphic symbols 407; a new complex object or a new complex activity can be formed by putting graphic symbols in a desired order or orientation or other supported manor 403, whereas 405 shows the meaning of the complex activity.

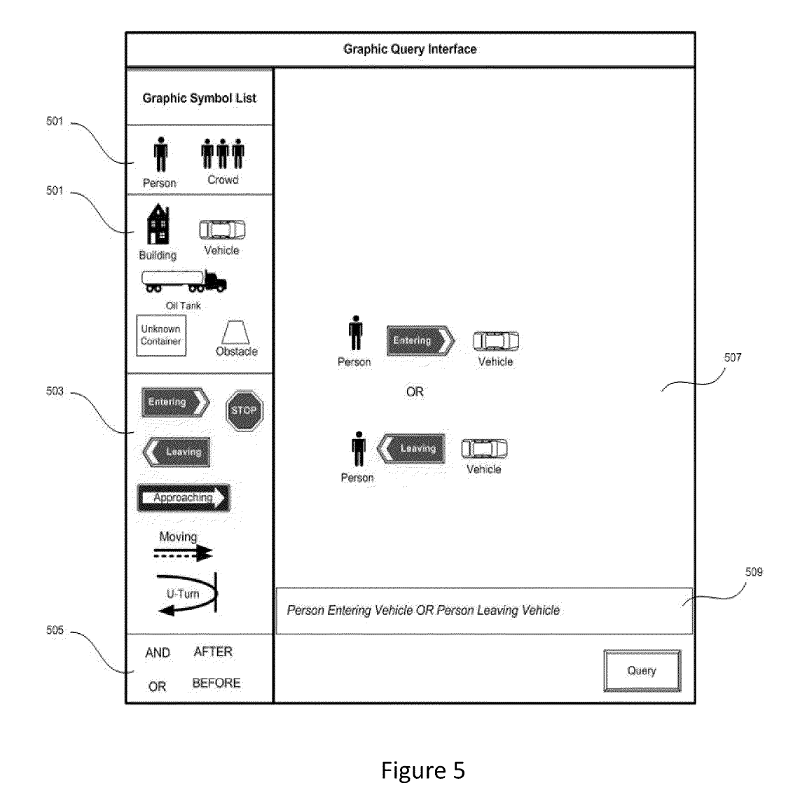

Referring to FIG. 5, similarly a query can be formed by grabbing objects symbols 501, activity symbols 503 and logic symbols 505 to make query into the database of objects and activities. The shown example in FIG. 5 is to query/search all instances (of video-clip and/or images) from the database of objects and activities that have activities of either “person entering vehicle” or “person leaving vehicle” 507 (symbolic) and 509 (texted). Other query language functions such as compose( ) or identify( ) can be added in the graphic query interface to achieve more flexible query experience.

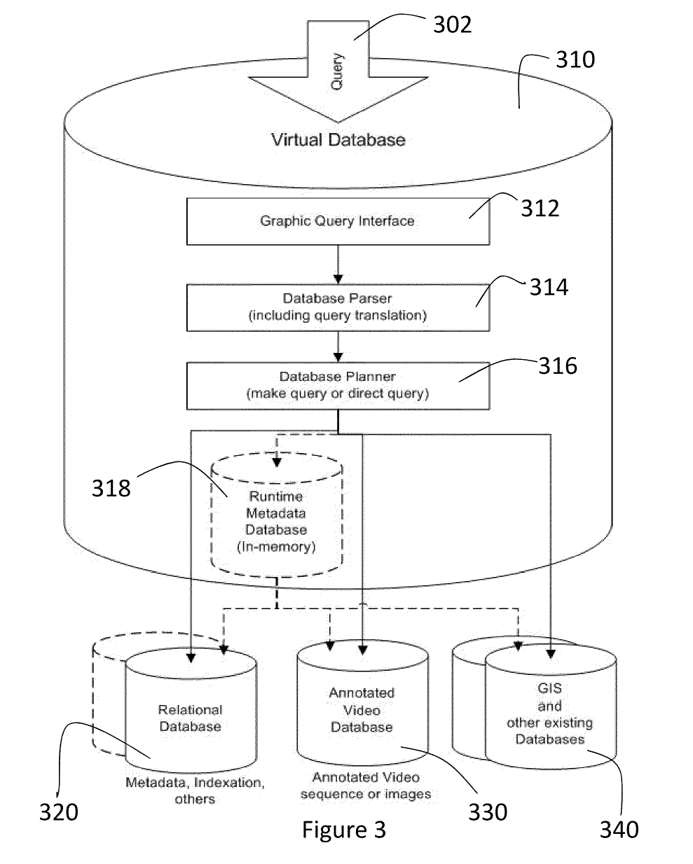

FIG. 3 illustrates another embodiment of database dataflow diagram when multiple member databases form a group of databases; which is a different view of FIG. 1. As shown in FIG. 3, a query 302 is input into virtual database 310, which has a graphic query interface 312, a database parser (including query translation) 314, a database planner 316, and a runtime metadata database 318. The virtual database 310 accesses relational database 320, annotated video database 330 and GIS and other existing databases 340.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A computer-implemented method for an object and activity query language wherein an object is a data type representing a thing or a being with a visual shape in an image or video frame and said activity is a data type representing an action or an event visually shown in an image or video or video frame, the method comprising the steps of:
storing a plurality of items in a raw data storage, said items comprising images and/or videos;
processing said items in a processor and to generate and/or segment annotated information from said items and to extract object, activity and/or metadata information from said items in said first data storage;
storing said annotated information in a secondary data storage;
storing said extracted object, activity, and/or metadata information and said annotated information in a primary data storage;
executing on a processor an identify function, wherein given a query item said identify function identifies said query item and/or finds a list of items similar to said first item; and a said query item comprises a video, a video frame, an image, a set of images, a template extracted from a video or image or images, an object, an activity, or annotated information; and
displaying results of said identify function.

2. A computer-implemented method for an object and activity query language according to claim 1, further comprising the steps of:
generating on said processor a complex object and/or activity from a plurality of existing objects or activities; and
storing said generated complex object and/or activity in said primary data storage.

3. A computer-implemented method for an object and activity query language according to claim 2, wherein said generated complex object and/or activity has a defined manor, said defined manor comprising an orientation or an order in which objects are located in physically or logically.

4. A computer-implemented method for an object and activity query language according to claim 1, further comprising the steps of:
providing a graphic user interface on a display, wherein graphic symbols are used to visually represent objects or activities.

5. A computer-implemented method for an object and activity query language according to claim 4, wherein said graphic query interface translates the graphic symbols entered by a user into query statements executed on said processor and displays a query result.

6. A computer-implemented method for an object and activity query language according to claim 5, wherein said graphic query interface combines multiple graphic symbols to form a query statement for a complex activity.

7. A computer-implemented method for an object and activity query language according to claim 6, wherein said graphic symbols comprise object graphic symbols representing a thing or a being with visual shape in an image or video frame.

8. A computer-implemented method for an object and activity query language according to claim 5, wherein said graphic user interface provides logic symbols permitting a user to form logical relationships between sub-statements.

9. A computer-implemented method for an object and activity query language according to claim 7, wherein said logic symbols comprise OR and AND.

10. A computer-implemented method for an object and activity query language according to claim 1, wherein said activity data type comprises one of an explosion, a movement of a person, or a movement of a vehicle.

11. A computer-implemented method for an object and activity query language according to claim 1, wherein said step of executing an identify function comprises combining a plurality of query score results.

12. A computer-implemented method for an object and activity query language according to claim 11, wherein said plurality of query score results come from a plurality of search engines.
